(19) United States
(12) Patent Application Publication
(10) Pub. No.: US 2019/0138382 A1
(43) Pub. Date: May 9, 2019

(54) INCIDENT RETRIEVAL METHOD AND INCIDENT RETRIEVAL APPARATUS

(71) Applicant: FUJITSU LIMITED, Kawasaki-shi (JP)

(72) Inventor: Masahiro Asaoka, Kawasaki (JP)

(73) Assignee: FUJITSU LIMITED, Kawasaki-shi (JP)

(21) Appl. No.: 16/179,273

(22) Filed: Nov. 2, 2018

(30) Foreign Application Priority Data
Nov. 6, 2017 (JP) 2017-213447

(51) Int. Cl. G06F 11/07; G06F 11/30

(52) U.S. Cl. CPC G06F 11/0781; G06F 11/0709; G06F 11/3072

(57) ABSTRACT

An incident retrieval apparatus includes a memory and a processor coupled to the memory. The processor is configured to extract one or more parameters from an output message in accordance with a predetermined rule. The output message contains one or more operation messages. The processor is configured to retrieve one or more incidents corresponding to the output message from an incident group including multiple incidents. The processor is configured to identify an output target incident among the retrieved one or more incidents depending on a number of appearance of the one or more parameters in operation information relating to an operation message in each incident of the one or more incidents. The processor is configured to output the output target incident.

### CROSS-REFERENCE TO RELATED APPLICATION

This application is based upon and claims the benefit of priority of the prior Japanese Patent Application No. 2017-213447, filed on Nov. 6, 2017, the entire contents of which are incorporated herein by reference.

### FIELD

The embodiment discussed herein is related to an incident retrieval method and an incident retrieval apparatus.

### BACKGROUND

For example, when a monitor apparatus receives a message that is output from a device constituting a system, an administrator of the system refers to an incident (a past record including information such as the cause of a fault and a measure against the fault) concerning a fault or the like corresponding to the message and deals with the fault or the like. The message may, for example, be collected by a computer in some cases.

As related techniques, a technique for supporting the retrieval of stored incident information is proposed. Another proposed technique is for filtering out the incidents that are relevant to entities and prioritizing those incidents that warrant attention.

A further proposed technique is for generating a resolution case for an incident. A still further proposed technique is for classifying, in accordance with the common location of causes of incidents, operation histories that have not been classified in detail.

Another proposed technique improves the accuracy of filtering failure messages. A further proposed technique is for generating a rule for appropriately consolidating messages.

Related techniques are disclosed in, for example, Japanese Laid-open Patent Publication No. 2017-4034, Japanese National Publication of International Patent Application No. 2011-516938, Japanese Laid-open Patent Publication No. 2014-178773, Japanese Laid-open Patent Publication No. 2015-153078, Japanese Laid-open Patent Publication No. 2014-106851, and Japanese Laid-open Patent Publication No. 2017-162196.

For example, every time an incident is generated, the incident is stored in a predetermined memory unit. However, it is possible that stored incidents are not associated with the above-described messages.

In such a case, it is difficult to identify an incident corresponding to a message. In a case where a single message is generated by consolidating multiple messages, it is also difficult to identify an incident corresponding to the single message.

### SUMMARY

According to an aspect of the present invention, provided is an incident retrieval apparatus including a memory and a processor coupled to the memory. The processor is configured to extract one or more parameters from an output message in accordance with a predetermined rule. The output message contains one or more operation messages. The processor is configured to retrieve one or more incidents corresponding to the output message from an incident group including multiple incidents. The processor is configured to identify an output target incident among the retrieved one or more incidents depending on a number of appearance of the one or more parameters in operation information relating to an operation message in each incident of the one or more incidents. The processor is configured to output the output target incident.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an overall configuration of a system;

FIG. 2 illustrates an example of functional blocks of an incident retrieval apparatus;

FIG. 3 illustrates an example of an operation message;

FIG. 4 illustrates an example of an incident;

FIG. 5 illustrates an example of an incident group;

FIG. 6 illustrates an example of operation message patterns;

FIG. 7 illustrates an example of extraction of parameters;

FIG. 8 illustrates an example of identification of an incident;

FIG. 9 illustrates an example of a report message;

FIG. 10 illustrates an example (example 1) of a consolidation filter;

FIG. 11 illustrates another example (example 2) of the consolidation filter;

FIG. 12 is a flowchart illustrating an example of a processing flow of an embodiment;

FIG. 13 is a flowchart (part 1) illustrating an example of a report message generation processing flow;

FIG. 14 is another flowchart (part 2) illustrating the example of the report message generation processing flow;

FIG. 15 is another flowchart (part 3) illustrating the example of the report message generation processing flow;

FIG. 16 is a flowchart illustrating an example of an output target incident identification processing;

FIG. 17 illustrates an example of weighting;

FIG. 18 illustrates an example of the degree of dependence on circumstances;

FIG. 19 is a flowchart illustrating an example of output target incident identification processing of a modified example; and

FIG. 20 illustrates an example of a hardware configuration of an incident retrieval apparatus.

### DESCRIPTION OF EMBODIMENTS

### Example of System of Embodiment

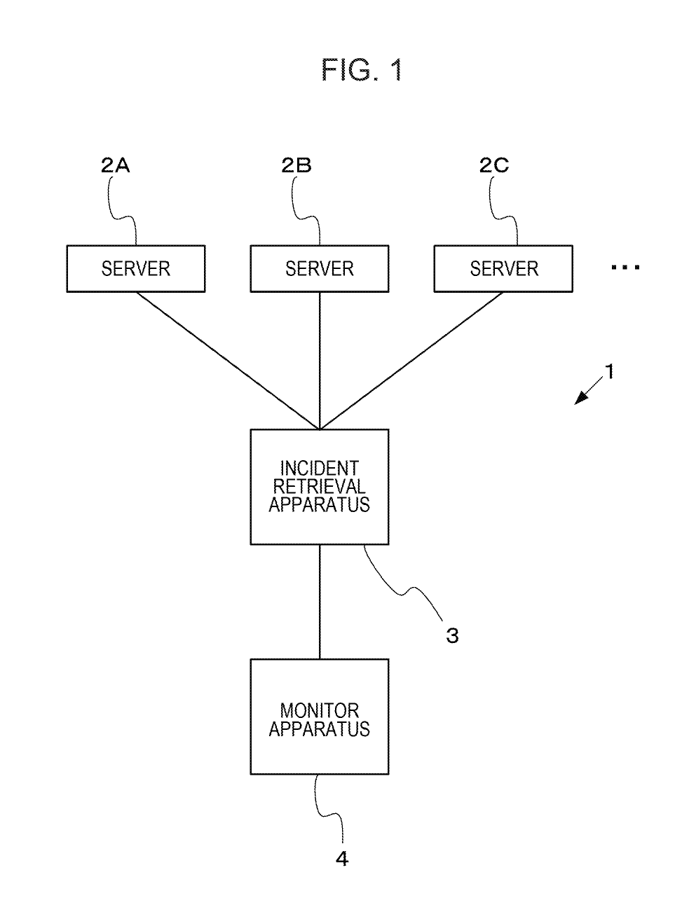

An embodiment is described below with reference to the drawings. FIG. 1 illustrates an example of an overall configuration of a system of an embodiment. In a system 1, multiple servers 2A, 2B, 2C, . . . (collectively referred to as servers 2) output messages about operational conditions of the servers 2 to an incident retrieval apparatus 3. In the following description, the message is referred to as an operation message. The operation message may be output from a device other than the server.

For example, the servers 2 each output the operation message to the incident retrieval apparatus 3 periodically or when any phenomenon (a fault, a failure, or the like) occurs in the servers 2. The servers 2 may output an operation message about a phenomenon other than a fault, a failure, or the like to the incident retrieval apparatus 3.

The incident retrieval apparatus 3 retrieves an incident corresponding to the operation message received from the servers 2. The incident is information on a fault that occurred in the past, information on the cause of the fault, and information on a measure against the fault in terms of a device of the system 1 (for example, one of the servers 2).

The incident retrieval apparatus 3 outputs a report message containing one or more operation messages to a monitor apparatus 4. The report message contains an output target incident. The report message is an example of an output message.

The monitor apparatus 4 is operated by, for example, a monitoring operator or the like. The monitor apparatus 4 may display the report message that is output by the incident retrieval apparatus 3 on, for example, a display or the like. In this case, the incident retrieval apparatus 3 controls the monitor apparatus 4 to display the report message on the display of the monitor apparatus 4.

When a monitoring operator takes any measure against a fault and the fault is resolved, the monitoring operator inputs to the monitor apparatus 4 information on the fault that occurred, information on the cause of the fault, information on the measure against the fault, and the like. The monitor apparatus 4 receives these kinds of information.

The monitor apparatus 4 outputs the above-described kinds of information to the incident retrieval apparatus 3, and as a result, an incident is stored in the incident retrieval apparatus 3. The incident may be stored in the incident retrieval apparatus 3 by way of methods other than the above-described method.

### Example of Incident Retrieval Apparatus

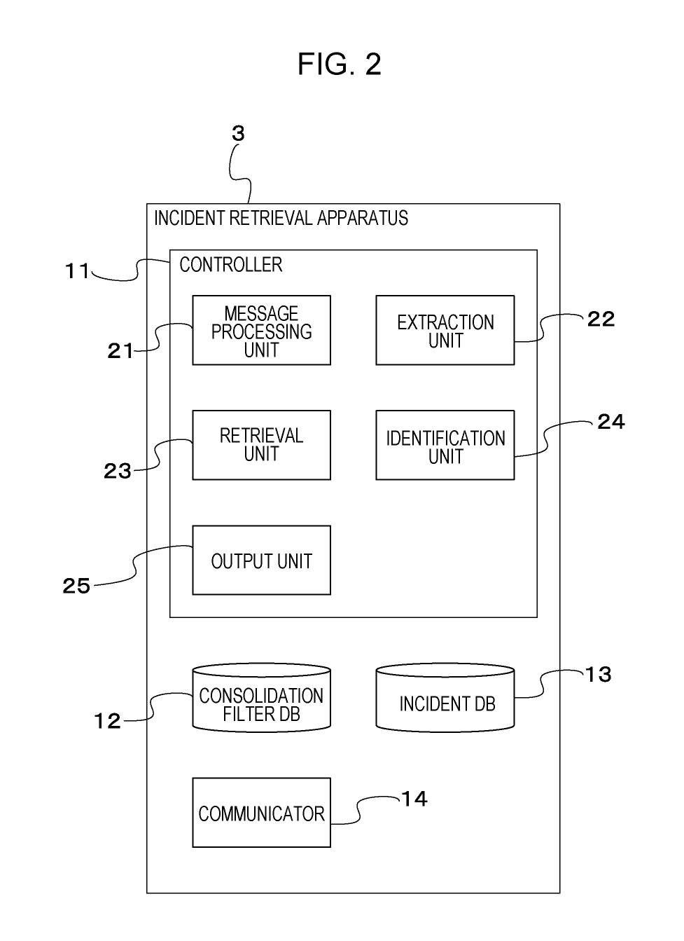

FIG. 2 illustrates an example of the incident retrieval apparatus 3. The incident retrieval apparatus 3 includes a controller 11, a consolidation filter database 12, an incident database 13, and a communicator 14. In the following description and the drawings, database is abbreviated as “DB”.

The controller 11 includes a message processing unit 21, an extraction unit 22, a retrieval unit 23, an identification unit 24, and an output unit 25. The controller 11 performs various kinds of processing according to the embodiment. The consolidation filter DB 12 stores multiple consolidation filters. The incident DB 13 stores multiple incidents. The communicator 14 communicates with apparatuses (the servers 2, the monitor apparatus 4, and the like) outside the incident retrieval apparatus 3.

The message processing unit 21 performs a predetermined processing operation for the operation message received by the incident retrieval apparatus 3. For example, the message processing unit 21 consolidates multiple operation messages by using a consolidation filter and generates a report message.

The extraction unit 22 extracts a parameter from the operation message or the report message in accordance with a predetermined rule. The retrieval unit 23 retrieves an incident corresponding to the message content of the received operation message. In this embodiment, it is assumed that multiple incidents are retrieved.

The identification unit 24 identifies an output target incident that is targeted for outputting to the monitor apparatus 4 among the multiple incidents retrieved by the retrieval unit 23. The output unit 25 associates the identified output target incident with a report message and outputs the report message including the associated output target incident.

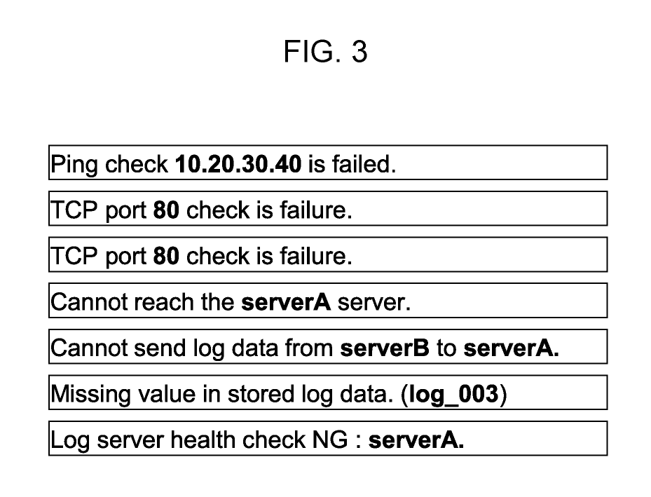

Next, an example of the operation message is described with reference to FIG. 3. In the example in FIG. 3, seven operation messages are illustrated. The number of the operation messages may be any number. In the example in FIG. 3, “Ping check 10.20.30.40 is failed.” is one of the operation messages. The operation message contains one more parameters. In the example in FIG. 3, parameters are indicated in bold. For example, in the aforementioned operation message, “10.20.30.40” is a parameter.

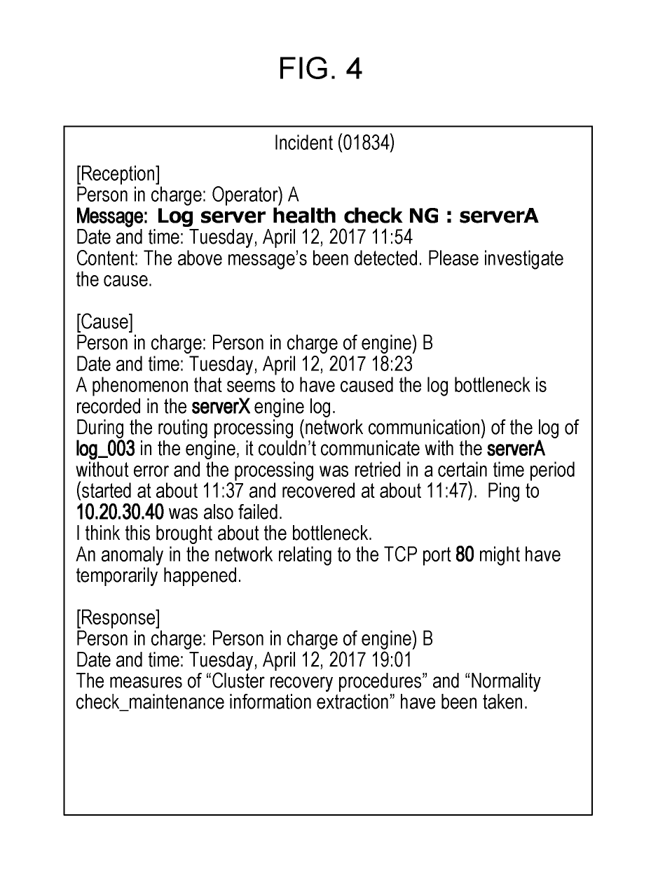

An example of an incident is described with reference to FIG. 4. Multiple kinds of information are recorded in an incident. In the incident, the “message” part corresponds to the operation message. The message is indicated in bold. In the example of an incident in FIG. 4, the message is “Log server health check NG:serverA”.

The incident is, for example, information about a fault. In the incident, information in the cause section is information about the cause of the fault. The information in the cause section is an example of information relating to the operation message and is written in an area of the incident other than the area in which the message is written.

In the incident, the information in the response section indicates the kind of measures that have been taken against the fault. As described above, the incident is information about the cause, the response, and the like that is input by an administrator of a system into the monitor apparatus 4 and that is received by the monitor apparatus 4.

In the example in FIG. 4, as indicated in bold, parameters are included in the cause section. For example, the cause section in the example of an incident in FIG. 4 includes five parameters: “serverX”, “log_003”, “serverA”, “10.20.30.40”, and “80”. This indicates that parts of an incident other than the message part also contain one or more parameters.

In the embodiment, the identification unit 24 identifies an incident targeted for output by using the parameter contained in the cause section of an incident. The information relating to the operation message may be written in an area other than the cause section of an incident.

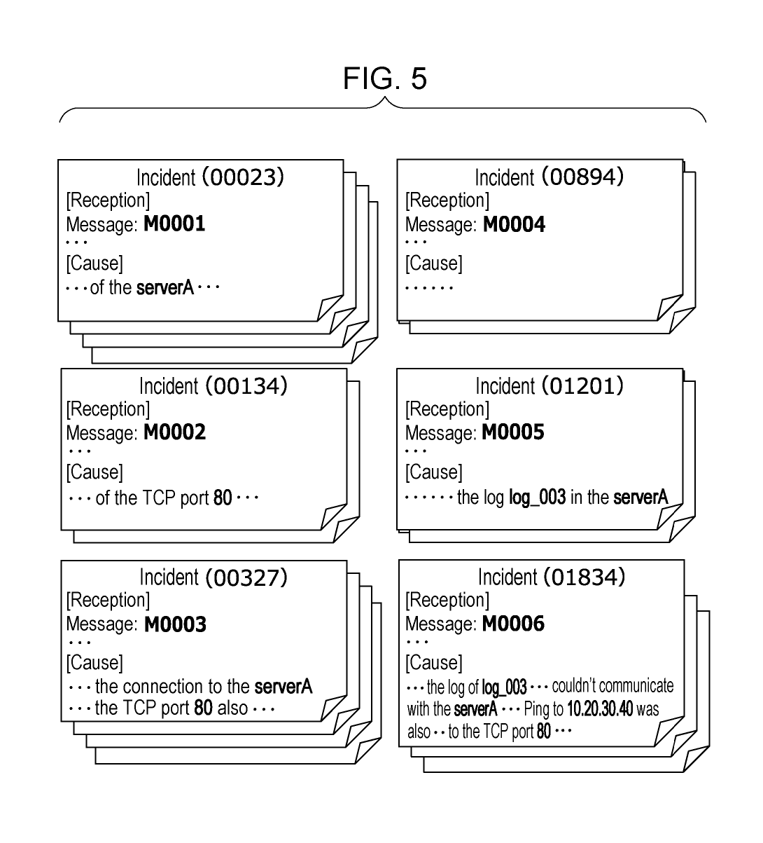

The incident DB 13 stores multiple incidents. FIG. 5 illustrates an example of multiple incidents stored in the incident DB 13. In the following description, the multiple incidents are referred to as an incident group in some cases.

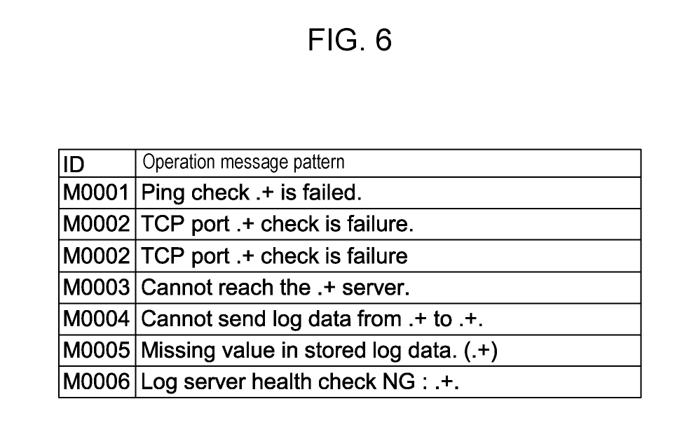

FIG. 6 illustrates an example of operation message patterns. An operation message pattern is used for matching with the operation message received by the incident retrieval apparatus 3. An identification (ID) is assigned to each of the operation message patterns. The operation message pattern is an example of the predetermined rule.

For example, it is assumed that the operation message “Ping check 10.20.30.40 is failed.” is received by the incident retrieval apparatus 3. The operation message matches the operation message pattern of “Ping check .+ is failed.”. The operation message pattern is expressed as regular expressions. In the example in FIG. 6, the “+” part is used as a wild card.

The operation message pattern may be preset in the incident retrieval apparatus 3 or generated based on the regularity in the operation messages received from the servers 2. The extraction unit 22 retains the operation message patterns as illustrated in FIG. 6.

When the incident retrieval apparatus 3 receives the operation message, the message processing unit 21 performs predetermined processing, consolidates the operation messages, and generates a report message. It is noted that a single operation message may be associated with a single report message.

In a case where the received operation message matches any of the operation message patterns, the extraction unit 22 extracts a parameter from the matched operation message. In the embodiment, the parameter of a parameter to be extracted is the portion used as a wild card.

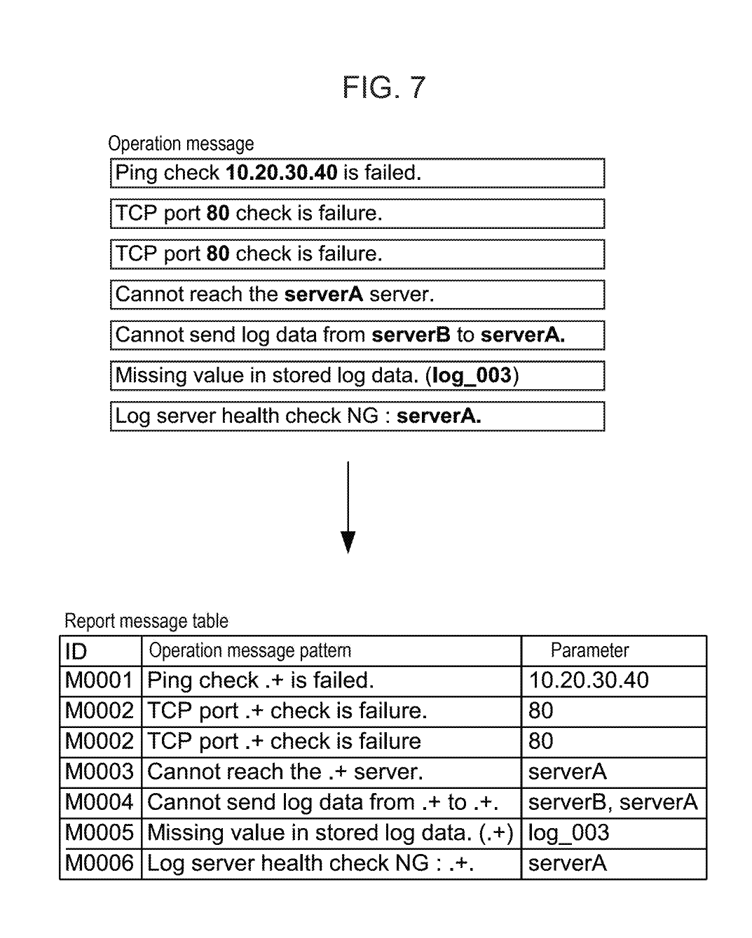

For example, in a case where the incident retrieval apparatus 3 receives the operation message “Ping check 10.20.30.40 is failed.”, as illustrated in the example in FIG. 7, the extraction unit 22 extracts the parameter “10.20.30.40” in accordance with the operation message pattern.

A report message table illustrated in FIG. 7 includes fields of ID, operation message pattern, and parameter. The message processing unit 21 populates the parameter field with a parameter corresponding to the operation message pattern. In the example in FIG. 7, two operation message patterns having the ID of “M0002” are the same operation message pattern. For example, in a case where the operation message pattern includes a time element, different IDs are assigned to the aforementioned same operation message patterns.

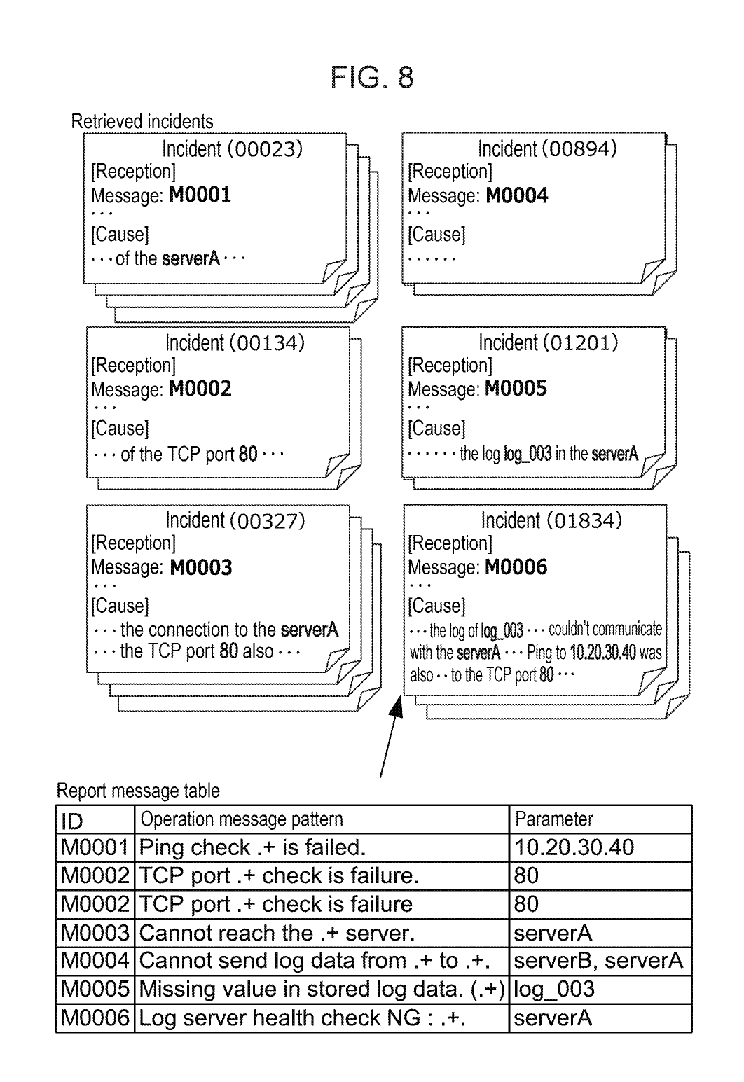

The retrieval unit 23 refers to the incident DB 13 and retrieves multiple incidents containing messages that match the operation message pattern in the report message table. Retrieved incidents illustrated in FIG. 8 are examples of incidents retrieved by the retrieval unit 23.

As illustrated in the example in FIG. 8, multiple incidents are obtained as the retrieval results in accordance with the operation message patterns. The number of multiple incidents is less than the total number of incidents stored in the incident DB 13 because the multiple incidents are the results of retrieval performed by the retrieval unit 23.

The identification unit 24 refers to the cause section of each of the retrieved multiple incidents, and when any of the parameters contained in the report message table are also included in the cause section, the identification unit 24 counts the number (the number of appearances) of the included parameters. The identification unit 24 identifies as an output target incident an incident in which the number of appearances of the parameters is the greatest.

In the example in FIG. 8, incident (01834) has the greatest number (the number of appearances) of the parameters that appear in the cause section. Hence, the identification unit 24 identifies the incident (01834) as an output target incident.

However, the operation message may not be associated with any incident. In addition, even in a case where the operation message is associated with an incident, it is difficult to identify an incident corresponding to a report message when the operation messages are consolidated as the report message.

As described above, the incident contains information other than the message (information in the cause section), and a parameter about the incident may be written to the information in the cause section. The incident that contains in its cause section the same parameter as that of an operation message is highly likely to correspond to the phenomenon (for example, a fault) indicated by the operation message.

The identification unit 24 counts the number of appearances of the parameters that are in the report message table and that are contained in the information other than the message and identifies an output target incident, thereby identifying the incident corresponding to the report message.

The identification unit 24 may identify multiple output target incidents in accordance with the number of appearances in the cause section. For example, the identification unit 24 may identify as output target incidents multiple incidents in which the number of appearances is a predetermined number or more.

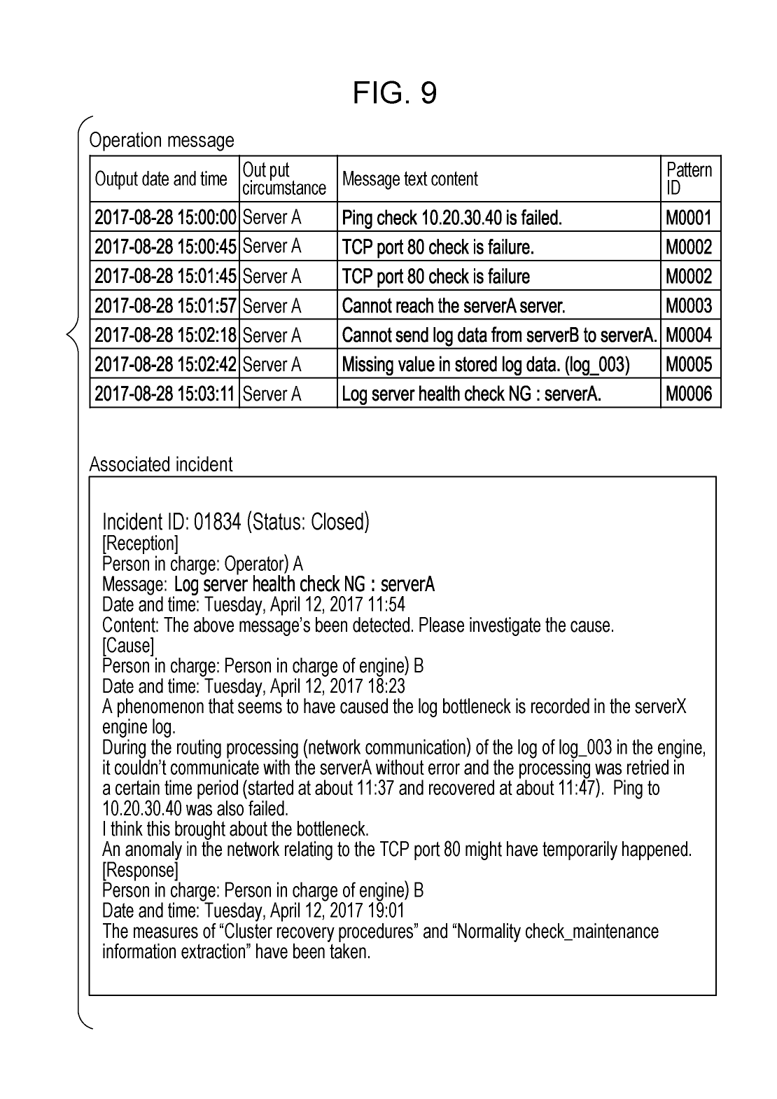

The output unit 25 outputs the report message. As illustrated in an example in FIG. 9, the report message contains one or more operation messages and an output target incident, and the one or more operation messages are associated with the output target incident. The output unit 25 may output the report message to the monitor apparatus 4.

By outputting to the monitor apparatus 4 the report message in which the operation messages and the output target incident are associated with each other, the monitor apparatus 4 may, for example, display on the display the operation messages and the output target incident in a state where the operation messages and the output target are associated with each other. In this case, the administrator of the system who operates the monitor apparatus 4 may check, on the display, the incident corresponding to the operation messages.

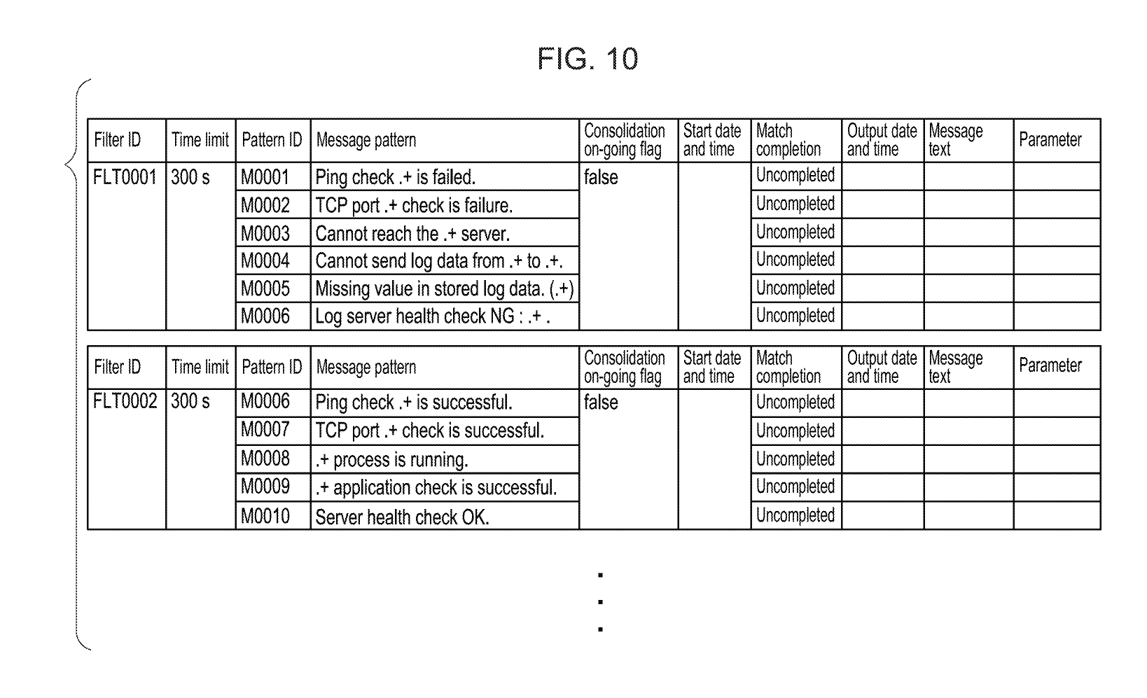

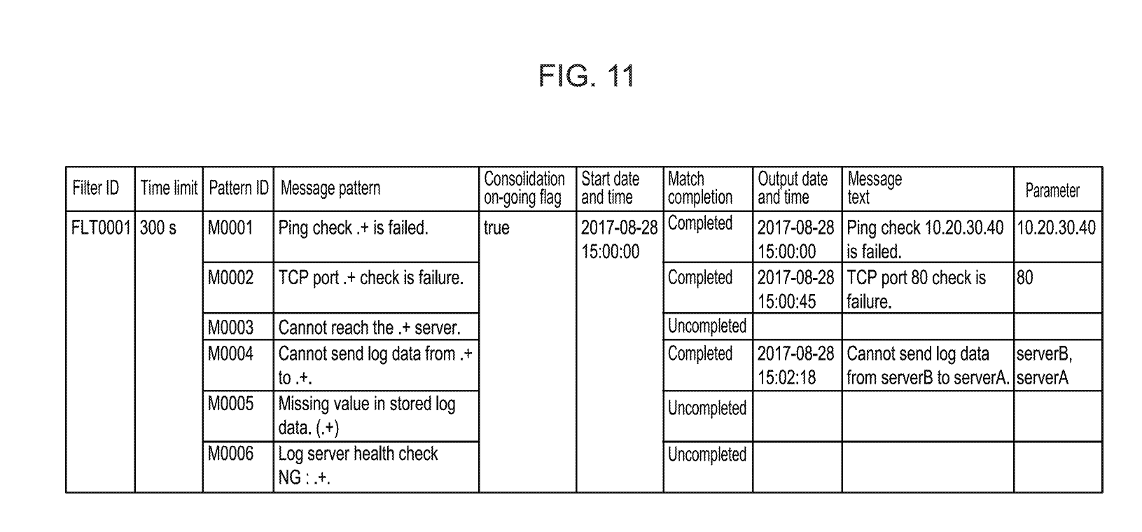

Next, the consolidation filter is described with reference to examples in FIGS. 10 and 11. The consolidation filter DB 12 stores multiple consolidation filters. The consolidation filter is used by the message processing unit 21 to consolidate operation messages and generates a report message.

As illustrated in an example in FIG. 10, the consolidation filter contains fields of filter ID, time limit, pattern ID, message pattern, consolidation on-going flag, start date and time, match completion, output date and time, message text, and parameter.

The filter ID is an identifier for identifying a consolidation filter. The time limit is a time period for which the consolidation filter is valid. For example, in a case where a consolidation filter is generated in accordance with the regularity in the operation messages, the regularity may vary, and thus the time limit is set for a consolidation filter.

The pattern ID is the same as the ID used in the report message table. The message pattern is the same as the operation message pattern in the report message. The consolidation on-going flag indicates whether the operation message is being consolidated by using the consolidation filter.

The start date and time indicates the date and time when use of the consolidation filter begins. The match completion is a flag indicating whether the operation message received by the incident retrieval apparatus 3 matches the message pattern.

The output date and time indicates the date and time when the matched operation message is output. The message text indicates the text of the matched operation message. The parameter indicates the parameter extracted from the matched operation message by the extraction unit 22.

FIG. 11 illustrates an example in which the operation message received by the incident retrieval apparatus 3 matches three message patterns in a consolidation filter. In the example in FIG. 11, the flag of the match completion for the matched message pattern is presented as “completed”.

### Example of Processing Flow of Embodiment

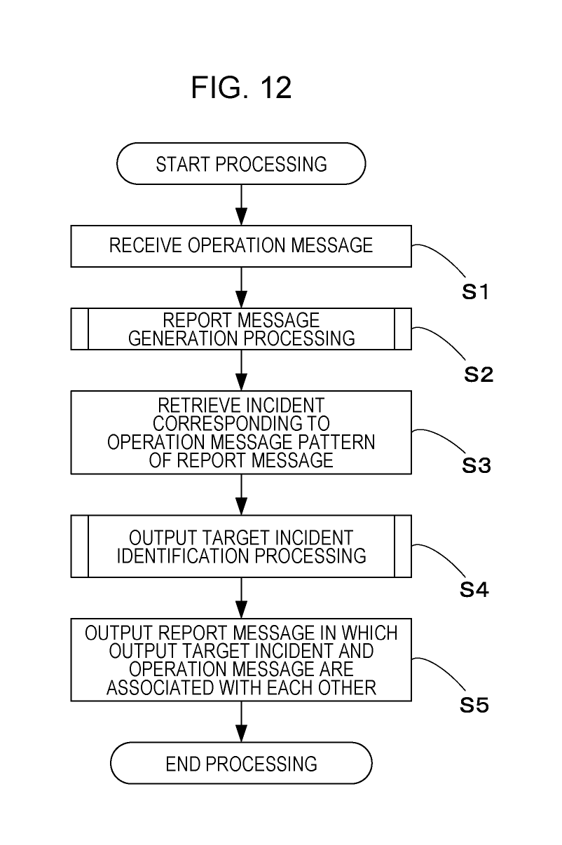

An example of a processing flow of the embodiment is described with reference to FIG. 12. After the servers 2 output the operation messages to the incident retrieval apparatus 3, the incident retrieval apparatus 3 receives the operation messages (step S1).

By performing consolidation processing for the operation messages received by the incident retrieval apparatus 3, the message processing unit 21 generates the report message (step S2).

The retrieval unit 23 refers to the incident DB 13 and retrieves an incident containing the operation message pattern of the report message in its message part among the incidents (step S3). In the embodiment, it is assumed that multiple incidents are obtained as retrieval results.

The identification unit 24 counts in the information written in the area (in this embodiment, the cause section) other than the operation message area the number of appearances of the parameters in the report message table for each of the multiple incidents. The identification unit 24 subsequently identifies an incident in which the number of appearances is the greatest as the output target incident (step S4).

The output unit 25 outputs the report message in which the identified output target incident and the operation message are associated with each other (step S5). The operation message may be obtained by consolidating multiple operation messages or may include a single operation message.

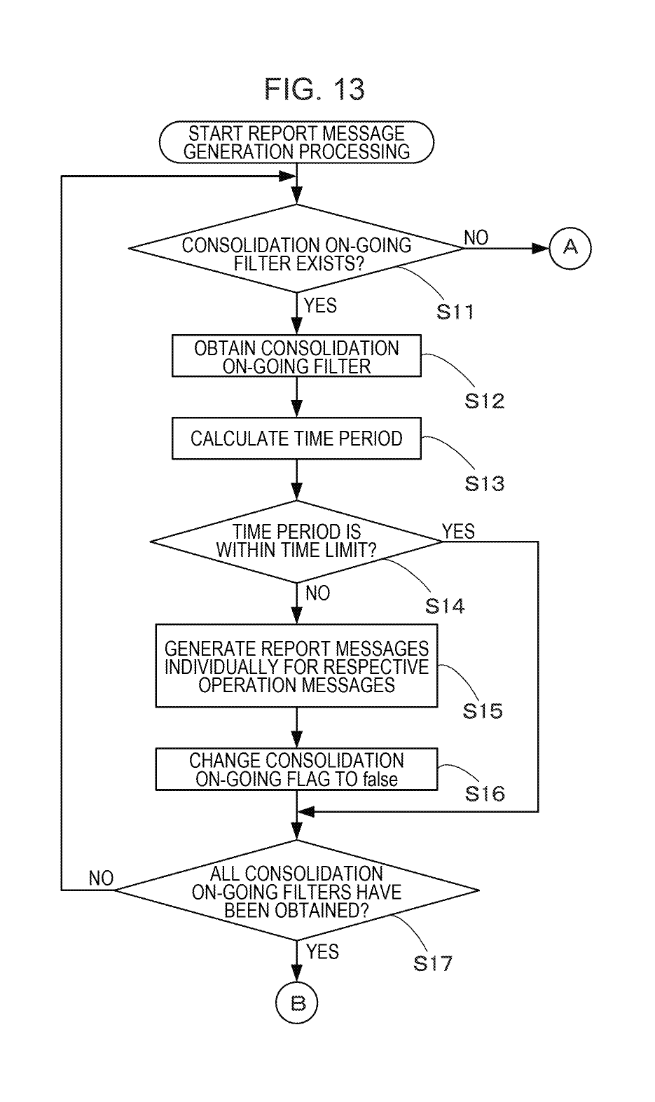

Next, report message generation processing is described with reference to flowcharts in FIGS. 13 to 15. In a case where the received operation message matches any of the consolidation filters in which the consolidation on-going flag is set to “false”, the message processing unit 21 changes the consolidation on-going flag of the consolidation filter to “true”.

The consolidation on-going flags of all consolidation filters stored in the consolidation filter DB 12 may be “false” in some cases. The message processing unit 21 determines whether the consolidation filter whose consolidation on-going flag is “true” exists (step S11). Hereinafter, the consolidation filter whose consolidation on-going flag is “true” is referred to as a consolidation on-going filter. In a case of NO in step S11, the processing flow moves to step S26.

In a case of YES in step S11, the message processing unit 21 obtains the consolidation filter whose consolidation on-going flag is “true” (step S12). In a case where multiple consolidation filters whose consolidation on-going flags are “true” are stored in the consolidation filter DB 12, the message processing unit 21 obtains one consolidation on-going filter among the multiple consolidation on-going filters.

The message processing unit 21 calculates the time period (the elapsed time) from the start date and time of the obtained consolidation on-going filter to the current date and time (step S13). The message processing unit 21 may retain the information about the current date and time.

The message processing unit 21 determines whether the calculated time period is within the time limit (step S14). In a case of NO in step S14, the calculated time period exceeds the time limit of the consolidation on-going filter.

In this case, the message processing unit 21 generates report messages individually for the respective operation messages registered in the message text in the consolidation on-going filter (step S15). For example, as illustrated in the example in FIG. 11, in a case where three operation messages are registered in the consolidation filter, the message processing unit 21 generates three report messages.

The consolidation on-going filter contains multiple message patterns. Because the message patterns have a mutual relationship, when the operation messages targeted for consolidation have been all registered, the message processing unit 21 generates a single report message by consolidating the registered operation messages.

If the operation messages of the consolidation on-going filter are consolidated when any of the operation messages targeted for consolidation has not been registered, the operation messages are consolidated in accordance with a rule different from the consolidation filter.

Hence, in a case of NO in step S14, the message processing unit 21 generates one report message for each of the operation messages registered in the message text of the consolidation on-going filter. The message processing unit 21 changes the consolidation on-going flag of the consolidation on-going filter targeted for the processing in step S15 to “false” (step S16).

In a case where the processing in step S16 is performed or in a case of YES in step S14, the message processing unit 21 determines whether all consolidation on-going filters stored in the consolidation filter DB 12 have been obtained (step S17). In a case of NO in step S17, the processing flow moves to step S11.

In a case of YES in step S17, all consolidation on-going filters stored in the consolidation filter DB 12 have been obtained. In this case, the processing flow moves to step S18.

The above-described processing operations in steps S11 to S17 relate to the time limit of the consolidation filter and may be performed at any timing. For example, the processing operations in steps S11 to S17 may be performed regularly or irregularly regardless of whether the incident retrieval apparatus 3 has received the operation message.

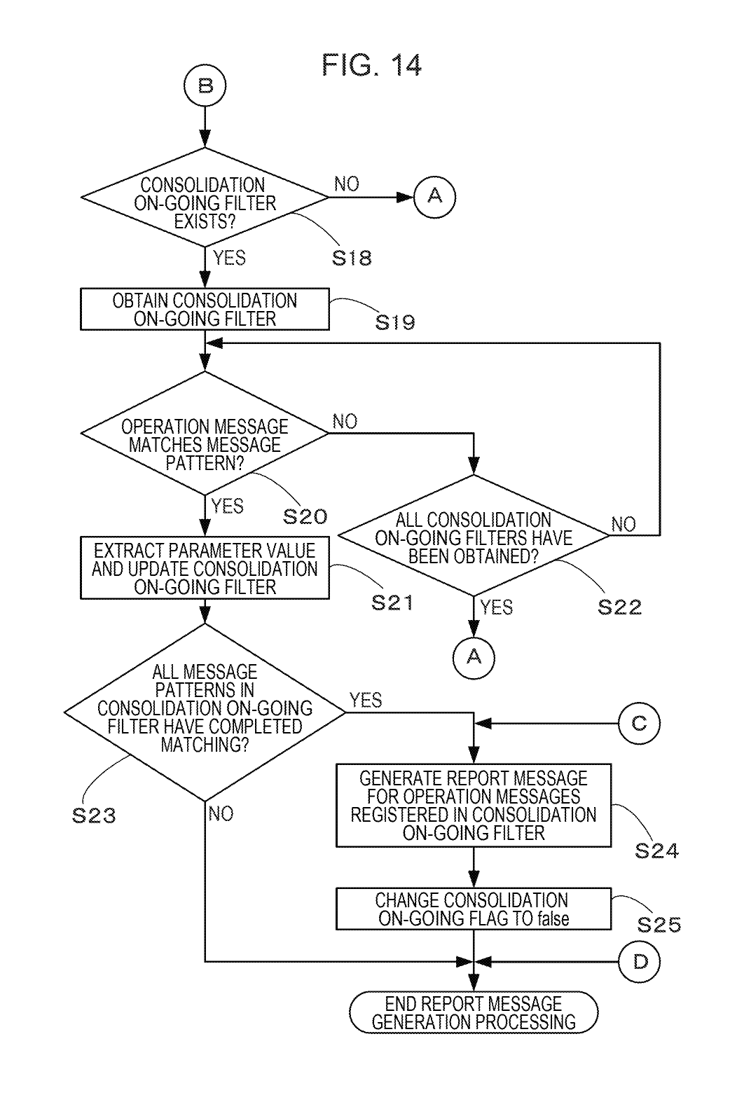

The processing operations from step S18 are described with reference to a flowchart in FIG. 14. Because the processing operations in steps S11 to S17 may be performed at any timing as described above, the message processing unit 21 may start the report message generation processing from step S18.

The message processing unit 21 determines whether the consolidation on-going filter exists (step S18). In a case of NO in step S18, the processing flow moves to step S26. In a case of YES in step S18, the message processing unit 21 obtains the consolidation on-going filter (step S19).

The message processing unit 21 determines whether the received operation message matches the message pattern in the obtained consolidation on-going filter (step S20). In a case of YES in step S20, the message processing unit 21 updates the consolidation on-going filter (step S21).

The message processing unit 21 registers the received operation message in the message text field corresponding to the matched message pattern in the consolidation on-going filter. The extraction unit 22 extracts a parameter that matches the aforementioned message pattern.

The message processing unit 21 registers the extracted parameter in the parameter field corresponding to the message pattern. In addition, the message processing unit 21 changes the match completion field corresponding to the message pattern from “uncompleted” to “completed”.

In a case of NO in step S20, the message processing unit 21 determines whether all consolidation on-going filters stored in the consolidation filter DB 12 have been obtained (step S22). In a case of NO in step S22, the processing flow moves to step S20. In a case of YES in step S22, the processing flow moves to step S26.

Following step S21, the message processing unit 21 determines whether all match completion fields in the consolidation on-going filter obtained in step S19 have been changed to “completed” (step S23). As described above, when all operation messages targeted for consolidation have been registered in the consolidation filter, the message processing unit 21 generates a single report message for the registered operation messages.

In a case of NO in step S23, not all operation messages targeted for consolidation have been registered in the consolidation on-going filter. In this case, the report message is not generated and the report message generation processing ends.

In a case of YES in step S23, all operation messages targeted for consolidation have been registered in the consolidation on-going filter. The message processing unit 21 generates a single report message for the operation messages registered in the consolidation on-going filter (step S24). Subsequently, the message processing unit 21 changes the consolidation on-going flag in the consolidation on-going filter obtained in step S19 to “false” (step S25).

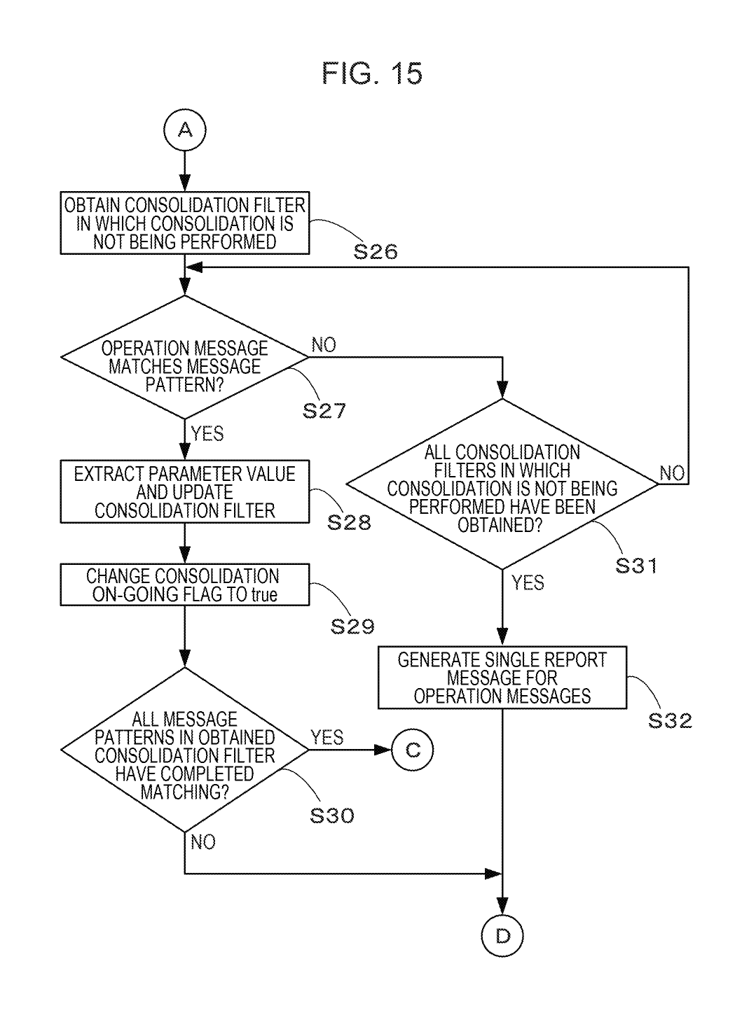

The processing operations from step S26 are described with reference to a flowchart in FIG. 15. The processing flow moves to the processing operations from step S26 in a case of No in step S11 in FIG. 13, in a case of NO in step S18 in FIG. 14, or in a case of YES in step S22 in FIG. 14.

The message processing unit 21 obtains the consolidation filter in which consolidation is not being performed (step S26). The message processing unit 21 determines whether the received operation message matches the message pattern in the obtained consolidation filter (step S27).

In a case of YES in step S27, the message processing unit 21 updates the consolidation on-going filter (step S28). The message processing unit 21 registers the received operation message in the message text field corresponding to the matched message pattern in the consolidation filter in which consolidation is not being performed. The extraction unit 22 extracts a parameter that matches the aforementioned message pattern.

The message processing unit 21 registers the extracted parameter in the parameter field corresponding to the message pattern. In addition, the message processing unit 21 changes the match completion field corresponding to the message pattern from “uncompleted” to “completed”. The message processing unit 21 performs the above-described processing operations and updates the consolidation filter in which consolidation is not being performed.

In a case of YES in step S27, the received operation message matches the message pattern in the consolidation filter obtained in step S26. In this case, consolidation of the operation messages by using the consolidation filter obtained in step S26 starts. Accordingly, the message processing unit 21 changes the consolidation on-going flag in the consolidation filter obtained in step S26 to “true” (step S29).

The message processing unit 21 determines whether all match completion fields in the consolidation filter obtained in step S26 have been changed to “completed” (step S30). In a case of YES in step S30, the processing flow moves to step S24.

Since all operation messages targeted for consolidation have been registered in the consolidation filter, the message processing unit 21 generates a single report message for the operation messages registered in the consolidation filter (step S24). Subsequently, the message processing unit 21 changes the consolidation on-going flag in the consolidation filter to “false” (step S25).

In a case of NO in step S30, some operation messages targeted for consolidation have not been registered in the consolidation filter. In this case, the report message is not generated and the report message generation processing ends.

In a case of NO in step S27, the message processing unit 21 determines whether all consolidation filters in which consolidation is not being performed have been obtained from the consolidation filter DB 12 (step S31). In a case of NO in step S31, the processing flow moves to step S27.

In a case of YES in step S31, the message processing unit 21 generates a single report message for the received operation messages (step S32). The report message generation processing subsequently ends.

Next, the output target incident identification processing in the flowchart in FIG. 12 is described. As illustrated in the flowchart in FIG. 12, in step S3, the retrieval unit 23 retrieves an incident corresponding to the operation message pattern in the report message. As described above, in this embodiment, multiple incidents are obtained as retrieval results.

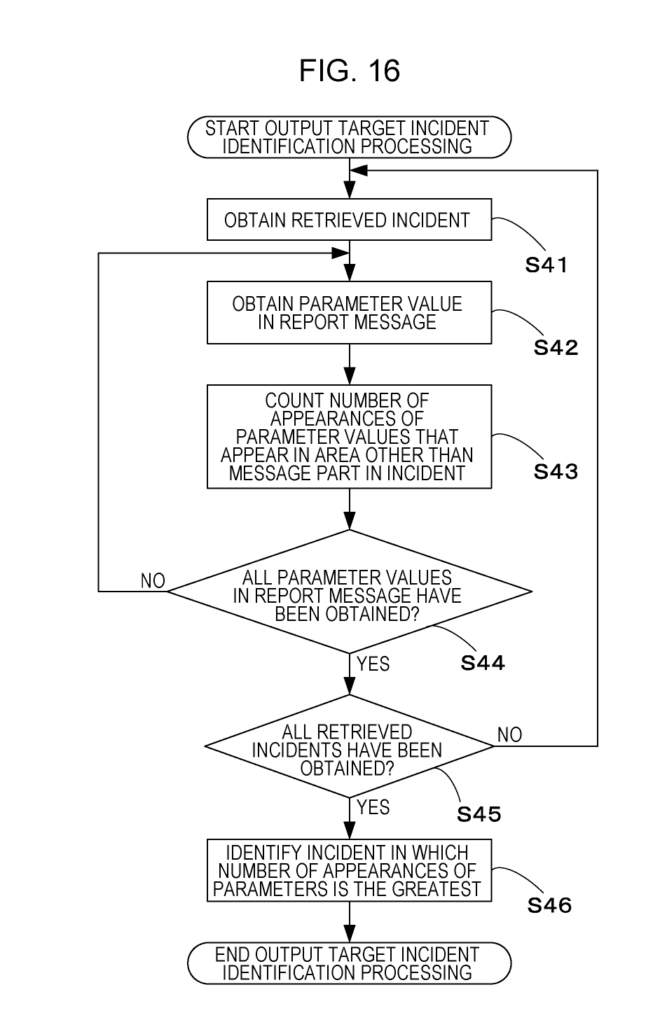

FIG. 16 is a flowchart illustrating an example of the output target incident identification processing. The identification unit 24 obtains the incident retrieved in step S3 (step S41). The identification unit 24 obtains a parameter from the parameter field in the report message table (step S42).

The identification unit 24 counts the number of appearances of the parameters that appear in the area other than the message part in the incident obtained in step S41 (step S43). In this embodiment, the identification unit 24 counts the number of parameters that appear in the cause section of the incident.

The identification unit 24 determines whether all parameters in the report message have been obtained (step S44). In a case of NO in step S44, the processing flow moves to step S42. In a case of YES in step S44, the identification unit 24 determines whether all retrieved incidents have been obtained (step S45).

In a case of NO in step S45, the processing flow moves to step S41. In a case of YES in step S45, the incident in which the number of appearances of the parameters is the greatest among the retrieved multiple incidents is identified as the output target incident (step S46). As a result, the output target incident is output.

### Modified Example

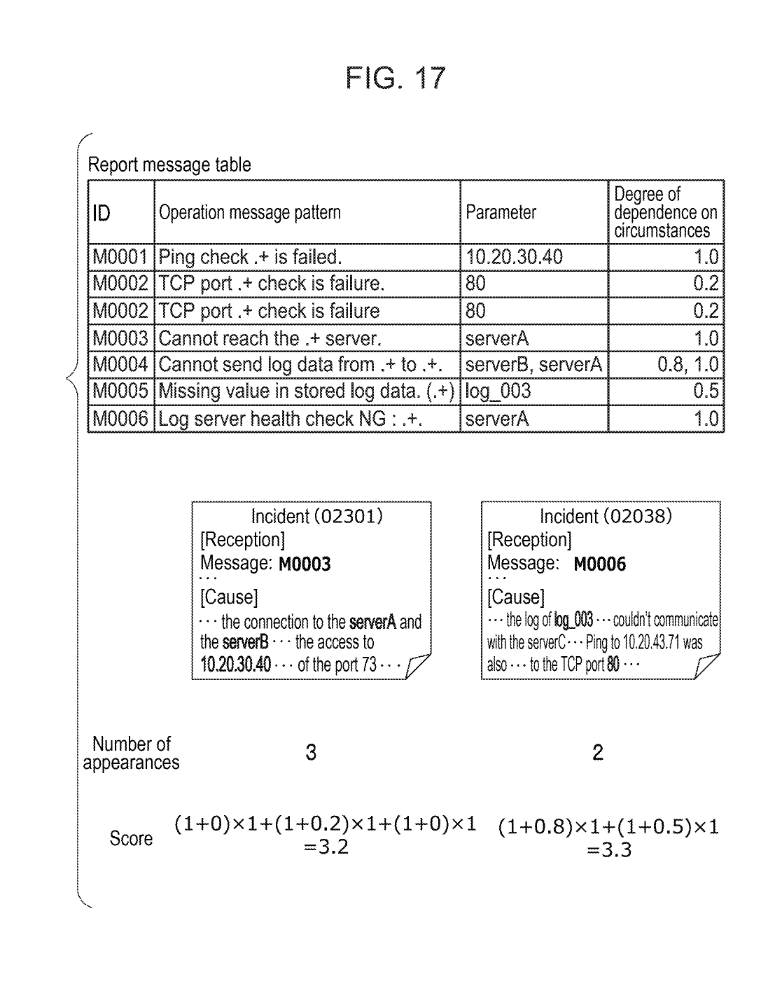

Next, a modified example is described. In FIG. 17, the report message table of the modified example is formed by adding the field of degree of dependence on circumstances to the above-described report message table. The degree of dependence on circumstances is the degree to which a parameter depends on specific output circumstances.

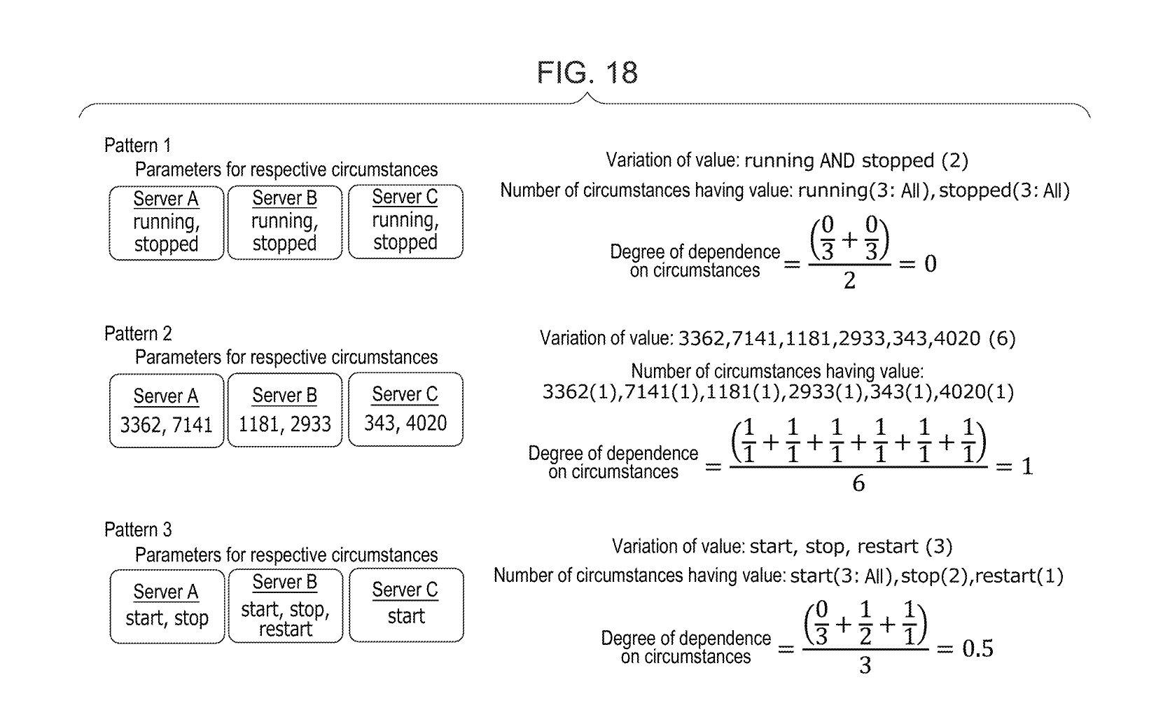

FIG. 18 illustrates an example of calculation of the degree of dependence on circumstances. In the example in FIG. 18, it is assumed that three servers 2 of servers A to C are connected to the incident retrieval apparatus 3. The incident retrieval apparatus 3 receives the operation messages from the servers A to C.

The degree of dependence on circumstances is calculated by the following equation.

$$Degree of dependence on circumstances = \sum ( ( \frac{X}{Number of circumstances having the parameter} ) \text{/} ( Number of variations of parameter ) )$$

In the above equation, in a case where all circumstances (the servers A to C) output the same parameter, X=0; or in a case where the above condition is not satisfied, X=1.

In a case of pattern 1 in FIG. 18, the parameter is “running” or “stopped”, and the number of variations of parameter is “2”. The incident retrieval apparatus 3 receives the parameter from all the servers A to C. “Number of circumstances having the parameter” in the above equation indicates the number of circumstances (for example, the servers 2) that output the operation messages containing the parameter. Accordingly, in the above-described case, “number of circumstances having the parameter ” is “3”.

Since all circumstances (the servers A to C) output the parameters of “running” and “stopped”, a condition in which all circumstances output the same parameter is satisfied, and therefore, X=0 and the degree of dependence on circumstances is “0”.

In a case of pattern 2 in FIG. 18, the parameters differ from one another and the number of variations of the parameter is “6”. In this case, since all parameters are different, the number of circumstances having the parameter is “1” for each of the parameters.

In the case of pattern 2, the condition in which all circumstances output the same parameter is not satisfied, and thus “X=1”. Accordingly, in the case of pattern 2, the degree of dependence on circumstances is “1”.

In a case of pattern 3 in FIG. 18, the parameters include three kinds: “start”, “stop”, and “restart”. The server A outputs “start” and “stop”, the server B outputs “start”, “stop”, and “restart”, and the server C outputs only “start”. Accordingly, the degree of dependence on circumstances of pattern 3 is “0.5”.

When a parameter is output from many circumstances, the degree of dependence on circumstances is low, and when a parameter is output from not many circumstances, the degree of dependence on circumstances is high. The parameter that is used by the identification unit 24 for identifying an incident relating to the operation message among multiple incidents is preferably output from many circumstances.

As described above, the identification unit 24 identifies an incident relating to the operation message among incidents in accordance with the number of appearances of parameters in the cause section. The parameters of the parameters may include both a parameter relating to a circumstance and a parameter relating to a phenomenon such as a fault.

For identifying an incident relating to the operation message, weighting parameters of the parameter relating to phenomena such as a fault is effective. For example, parameters of a parameter relating to phenomena such as a fault are output from many circumstances.

In the modified example, the identification unit 24 weights the number of appearances of parameters in the cause section of an incident in accordance with the degree of dependence on circumstances. Hereinafter, a weighted value of the number of appearances may be referred to as a score. The score according to the modified example is expressed by the following equation.

“Score=(1+(1−degree of dependence on circumstances))×number of appearances of parameters”

The value of (1−degree of dependence on circumstances) increases as the degree of dependence on circumstances decreases, and thus the score also increases. Conversely, the value of (1−degree of dependence on circumstances) decreases as the degree of dependence on circumstances increases, and thus the score also decreases.

Referring to the example in FIG. 17, the number of appearances of the parameters written in the cause section of the incident (02038) is “2”, and the score of the incident (02038) obtained by the identification unit 24 performing the above-described weighting is “3.3”. This is because the degree of dependence on circumstances of the parameter “80” in the incident (02038) is low and the degree of dependence on circumstances of the parameter “log_003” is also not high.

In contrast, the number of appearances of the parameters written in the cause section of the incident (02301) is “3”, and even though the identification unit 24 performs the above-described weighting, the score of the incident (02301) is “3.2” and there is almost no change in the score. This is because three parameters in the incident (02301) each have a relatively higher degree of dependence on circumstances.

By performing weighting in accordance with the degree of dependence on circumstances, the identification unit 24 identifies, as the output target incident, the incident (02038) having a higher score rather than the incident (02301) having a larger number of appearances of parameters.

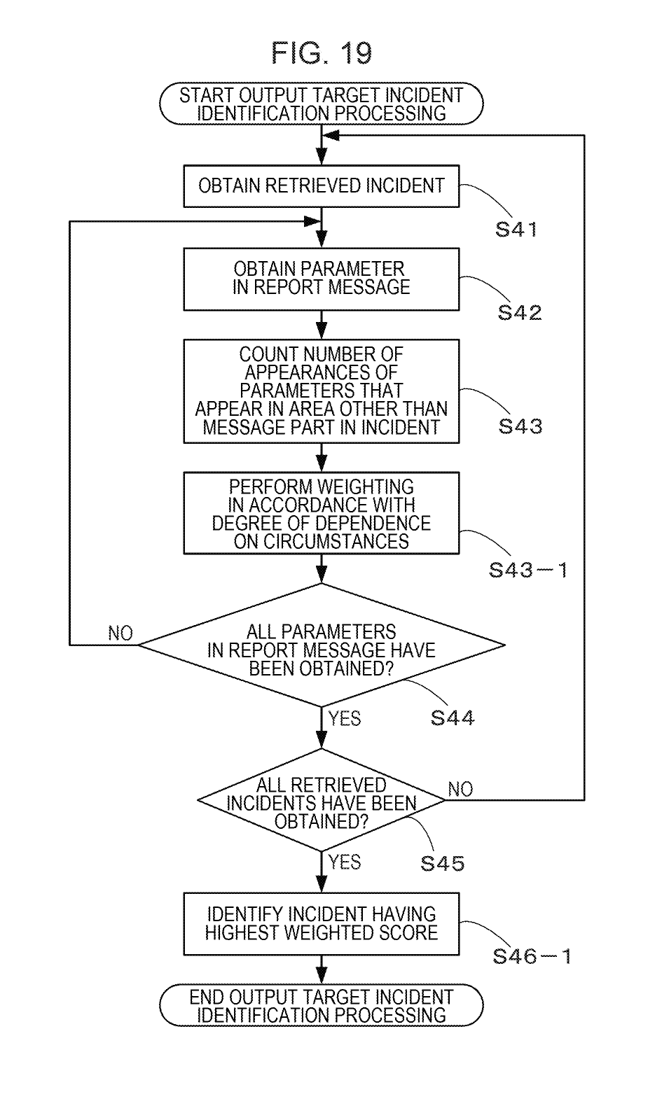

FIG. 19 is a flowchart of output target incident identification processing of the modified example. In the flowchart in FIG. 19, steps except for steps S43-1 and S46-1 are the same as those of FIG. 16 and the description is omitted.

After the processing of step S33, as described above, the identification unit 24 weights the number of appearances in accordance with the degree of dependence on circumstances (step S43-1). In a case of YES in step S45, the identification unit 24 identifies an incident having the highest weighted score (step S46-1).

### Example of Hardware Configuration of Incident Retrieval Apparatus

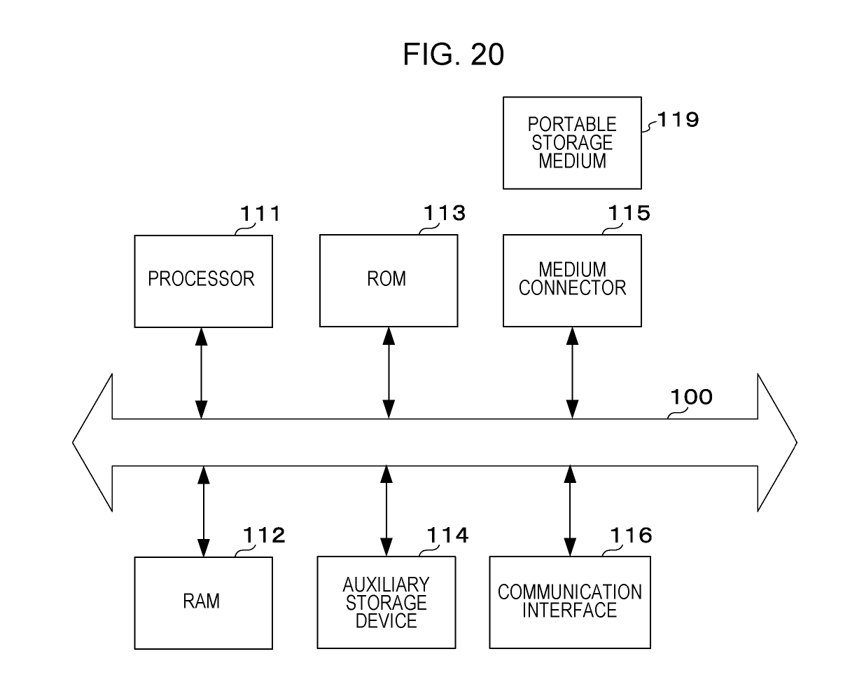

Next, an example of a hardware configuration of the incident retrieval apparatus 3 is described with reference to an example in FIG. 20. As illustrated in the example in FIG. 20, a processor 111, a random access memory (RAM) 112, a read-only memory (ROM) 113, an auxiliary storage device 114, a medium connector 115, and a communication interface 116 are coupled to a bus 100.

The processor 111 is an arbitrary processing circuit. The processor 111 executes a program loaded in the RAM 112. A program for performing processing of the embodiment may be applied as the program to be executed. The ROM 113 is a non-volatile storage device that stores a program to be loaded in the RAM 112.

The auxiliary storage device 114 is a storage device that stores various types of information, and, for example, a hard disk drive or a semiconductor memory may be applied as the auxiliary storage device 114. The medium connector 115 is provided so as to be capable of being connected to a portable storage medium 119.

A portable semiconductor memory or a portable optical disc (for example, a compact disc (CD) or a digital versatile disc (DVD)) may be applied as the portable storage medium 119. The portable storage medium 119 may store a communication control program for performing processing of the embodiment.

In the incident retrieval apparatus 3, the consolidation filter DB 12 and the incident DB 13 may be implemented as, for example, the RAM 112 and the auxiliary storage device 114. The communicator 14 may be implemented as the communication interface 116. The controller 11 may be implemented by the processor 111 executing a given incident retrieval program.

The RAM 112, the ROM 113, the auxiliary storage device 114, and the portable storage medium 119 are examples of tangible computer-readable storage media. Those tangible storage media are not temporary media such as a signal carrier wave.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
extracting one or more parameters from an output message in accordance with a predetermined rule, the output message containing one or more operation messages;
retrieving one or more incidents corresponding to the output message from an incident group including multiple incidents;
identifying an output target incident among the retrieved one or more incidents depending on a number of appearance of the one or more parameters in operation information relating to an operation message in each incident of the one or more incidents; and
outputting the output target incident.

2. The non-transitory computer-readable recording medium according to claim 1, wherein the operation information is written to a first area of each of the multiple incidents included in the incident group and that is other than an area to which the operation message is written.

3. The non-transitory computer-readable recording medium according to claim 2, wherein information written to the first area indicates a cause of a fault indicated by the operation message.

4. The non-transitory computer-readable recording medium according to claim 1, the process further comprising:
identifying, as the output target incident, an incident having a greatest number of appearances of the one or more parameters included in the operation information among the retrieved one or more incidents.

5. The non-transitory computer-readable recording medium according to claim 1, the process further comprising:
weighting a number of appearances of the one or more parameters included in the operation information in accordance with a dependence degree to which each of the one or more parameters depends on a performance circumstance that outputs a relevant operation message; and
identifying the output target incident depending on the weighted number of appearances of the one or more parameters.

6. The non-transitory computer-readable recording medium according to claim 5, the process further comprising:
performing the weighting such that the number of appearances of the one or more parameters is weighted greater as the dependence degree is lower; and
identifying, as the output target incident, an incident having a greatest weighted value of the number of appearances of the one or more parameters among the retrieved one or more incidents.

7. The non-transitory computer-readable recording medium according to claim 1, the process further comprising:
outputting a report message, the report message containing the one or more operation messages and the output target incident.

8. The non-transitory computer-readable recording medium according to claim 7, the process further comprising:
consolidating multiple operation messages included in the one or more operation messages in a case where all of patterns set in a consolidation filter for consolidating operation messages match any of the multiple operation messages;
generating a first report message in which the consolidated multiple operation messages are associated with the output target incident; and
outputting the report message.

9. The non-transitory computer-readable recording medium according to claim 8, the process further comprising:
generating second report messages in a case where some of the patterns match none of the multiple operation messages within a predetermined time limit, the second report messages each including one of the multiple operation messages.

10. An incident retrieval method, comprising:
extracting, by a computer, one or more parameters from an output message in accordance with a predetermined rule, the output message containing one or more operation messages;
retrieving one or more incidents corresponding to the output message from an incident group including multiple incidents;
identifying an output target incident among the retrieved one or more incidents depending on a number of appearance of the one or more parameters in operation information relating to an operation message in each incident of the one or more incidents; and
outputting the output target incident.

11. An incident retrieval apparatus, comprising:
a memory; and
a processor coupled to the memory and the processor configured to:
extract one or more parameters from an output message in accordance with a predetermined rule, the output message containing one or more operation messages;
retrieve one or more incidents corresponding to the output message from an incident group including multiple incidents;
identify an output target incident among the retrieved one or more incidents depending on a number of appearance of the one or more parameters in operation information relating to an operation message in each incident of the one or more incidents; and
output the output target incident.
